(19) United States
(12) Patent Application Publication
(10) Pub. No.: US 2015/0123583 A1
(43) Pub. Date: May 7, 2015

(54) MOTOR DRIVING CONTROL APPARATUS AND METHOD, AND MOTOR SYSTEM USING THE SAME

(71) Applicant: Samsung Electro-Mechanics Co., Ltd., Suwon-Si (KR)

(72) Inventor: Joo Yul Ko, Suwon-Si (KR)

(73) Assignee: SAMSUNG ELECTRO-MECHANICS CO., LTD., Suwon-Si (KR)

(21) Appl. No.: 14/285,418

(22) Filed: May 22, 2014

(30) Foreign Application Priority Data
Nov. 1, 2013 (KR) 10-2013-0132433

(51) Int. Cl. H02P 6/18

(52) U.S. Cl. CPC H02P 6/182
USPC 318/400.35

(57) ABSTRACT

A motor driving control apparatus may include a zero cross point (ZCP) detecting unit detecting back electromotive force generated by a motor apparatus and detecting a plurality of zero cross points in the back electromotive force, a zero cross point correcting unit correcting the plurality of zero cross points when a time interval between the plurality of zero cross points is equal to a predetermined error period or longer, and a controlling unit controlling driving of the motor apparatus using the plurality of corrected zero cross points.

### CROSS-REFERENCE TO RELATED APPLICATION

This application claims the benefit of Korean Patent Application No. 10-2013-0132433 filed on Nov. 1, 2013, with the Korean Intellectual Property Office, the disclosure of which is incorporated herein by reference.

### BACKGROUND

The present disclosure relates to a motor driving control apparatus and method, and a motor system using the same.

In accordance with the development of a motor technology, motors having various sizes have been used in a wide range of technological fields.

Generally, a motor is driven by rotating a rotor using a permanent magnet and a coil having polarities changed according to a current applied thereto. Initially, a brush type motor in which a rotor is provided with a coil was provided. However, such a motor may have problems such as brush abrasion, spark generation, or the like, due to driving thereof.

Therefore, recently, various types of brushless motor have generally been used. A brushless motor is a direct current (DC) motor driven using an electronic commutation mechanism instead of mechanical contact parts such as a brush, a commutator, and the like. Such a brushless motor may generally include a stator including coils and generating magnetic force within respective coils through phase voltages, and a rotor formed of a permanent magnet and rotated by electromagnetic magnetic force generated in the stator.

In order to control the driving of the brushless motor, it is necessary to confirm a position of the rotor so as to alternately provide the phase voltages. According to the related art, the position of the rotor has been estimated using back-electromotive force in order to confirm the position of the rotor. For example, a scheme of using a zero cross point of back electromotive force to determine a phase shift time has mainly been used.

According to the related art described above, however, in the case in which an error is generated upon detecting back electromotive force, the phase shifting time generally becomes erroneous.

For example, parasitic capacitance may be present in a switch of an inverter, thereby causing a predetermined negative current. The negative current causes a voltage drop, such that an error in detecting the zero cross point may be caused.

The following Related Art Documents relate to the motor technology as described above and have a limitation that they do not solve the problem of errors in back electromotive force, as described above.

### SUMMARY

An aspect of the present disclosure may provide a motor driving control apparatus and method capable of accurately driving a motor by correcting an error in a zero cross point of back electromotive force, and a motor system using the same.

According to an aspect of the present disclosure, a motor driving control apparatus may include: a zero cross point (ZCP) detecting unit detecting back electromotive force generated by a motor apparatus and detecting a plurality of zero cross points in the back electromotive force; a zero cross point correcting unit correcting the plurality of zero cross points when a time interval between the plurality of zero cross points is equal to a predetermined error period or longer; and a controlling unit controlling driving of the motor apparatus using the plurality of corrected zero cross points.

The zero cross point correcting unit may average errors within the time interval between the plurality of zero cross points to perform a correction.

The zero cross point correcting unit may determine that the error is present when a first interval between a first zero cross point and a second zero cross point and a second interval between the second zero cross point and a third zero cross point are different from each other.

The zero cross point correcting unit may calculate an average value of a difference between the first interval and the second interval and reflect the calculated average value in the first and second intervals, respectively.

The zero cross point correcting unit may subtract the average value from a larger interval between the first interval and the second interval and add the average value to the remaining interval.

The zero cross point correcting unit may include: a period detector detecting periods of the plurality of zero cross points; an error detector selecting at least two intervals between adjacent zero cross points among the plurality of zero cross points detected by the period detector and determining whether the at least two selected intervals are different from each other; and a corrector performing a correction using an average value of a difference between the two intervals, for the at least two intervals in which a presence of the error is determined by the error detector.

According to another aspect of the present disclosure, a motor system may include: a motor apparatus performing a rotation operation according to a driving signal; and a motor driving control apparatus detecting a plurality of zero cross points (ZCPs) using back electromotive force generated by the motor apparatus and correcting the plurality of zero cross points when the plurality of zero cross points are not equal to each other to generate the driving signal.

The motor driving control apparatus may include: a zero cross point (ZCP) detecting unit detecting the back electromotive force generated by the motor apparatus and detecting the plurality of zero cross points in the back electromotive force; a zero cross point correcting unit correcting the plurality of zero cross points when a time interval between the plurality of zero cross points is equal to a predetermined error period or longer; and a controlling unit controlling driving of the motor apparatus using the plurality of corrected zero cross points.

The zero cross point correcting unit may average errors within the time interval between the plurality of zero cross points to perform a correction.

The zero cross point correcting unit may determine that the error is present when a first interval between a first zero cross point and a second zero cross point and a second interval between the second zero cross point and a third zero cross point are different from each other.

The zero cross point correcting unit may calculate an average value of a difference between the first interval and the second interval and reflect the calculated average value in the first and second intervals, respectively.

The zero cross point correcting unit may subtract the average value from a larger interval between the first interval and the second interval and add the average value to the remaining interval.

The zero cross point correcting unit may include: a period detector detecting periods of the plurality of zero cross points; an error detector selecting at least two intervals between adjacent zero cross points among the plurality of zero cross points detected by the period detector and determining whether the at least two selected intervals are different from each other; and a corrector performing a correction using an average value of a difference between the two intervals, for the at least two intervals in which a presence of the error is determined by the error detector.

According to another aspect of the present disclosure, a motor driving control method performed in a motor driving control apparatus controlling driving of a motor apparatus may include: detecting a plurality of zero cross points (ZCPs) using back electromotive force generated by the motor apparatus; and correcting the plurality of zero cross points when a time interval between the plurality of zero cross points is equal to a predetermined error period or longer.

The correcting of the plurality of zero cross points may include averaging the error for the time interval between the plurality of zero cross points to perform a correction.

The correcting of the plurality of zero cross points may include: determining that the error is present when a first interval between a first zero cross point and a second zero cross point and a second interval between the second zero cross point and a third zero cross point are different from each other; and calculating an average value of a difference between the first interval and the second interval and reflecting the calculated average value in the first and second intervals, respectively.

The reflecting of the calculated average value in the first and second intervals, respectively, may include subtracting the average value from a larger interval between the first interval and the second interval; and adding the average value to the remaining interval between the first interval and the second interval.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram illustrating an example of a motor system according to an exemplary embodiment of the present disclosure;

FIG. 2 is a reference diagram illustrating a zero cross point of back electromotive force in the case in which an error is not present;

FIG. 3 is a reference diagram illustrating a zero cross point of back electromotive force in the case in which an error is present;

FIG. 4 is a reference diagram comparing G1 of FIG. 2 and G2 of FIG. 3 with each other;

FIG. 5 is a block diagram illustrating an example of a zero cross point correcting unit 150 of FIG. 1;

FIG. 6 is a flow chart illustrating an example of a motor driving control method according to an exemplary embodiment of the present disclosure; and

FIG. 7 is a flow chart illustrating an example of 5620 of FIG. 6.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

In addition, hereinafter, a motor device will be termed a motor apparatus 200, and an apparatus including a motor driving control apparatus 100 for driving the motor apparatus 200 and the motor apparatus 200 will be termed a motor system.

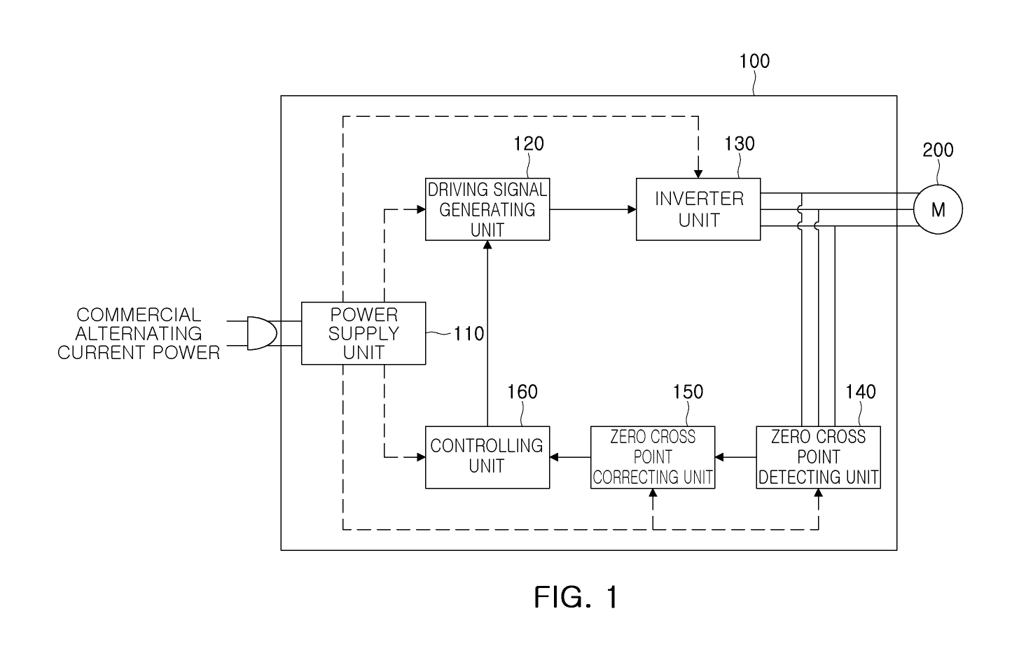

FIG. 1 is a block diagram illustrating an example of a motor system according to an exemplary embodiment of the present disclosure.

The motor apparatus 200 may perform a rotation operation according to a driving signal. For example, the respective coils of the motor apparatus 200 may generate magnetic fields by a driving current (driving signal) provided from an inverter unit 130. The rotor included in the motor apparatus 200 may be rotated by the magnetic fields generated by the coils.

The motor driving control apparatus 100 may provide a predetermined signal, for example, a driving signal to a motor apparatus 200 to control a rotation operation of the motor apparatus 200.

In further detail, the motor driving control apparatus 100 may include a power supply unit 110, a driving signal generating unit 120, the inverter unit 130, a zero cross point detecting unit 140, a zero cross point (ZCP) correcting unit 150, and a controlling unit 160.

The power supply unit 110 may supply power to the respective components of the motor driving control apparatus 100. For example, the power supply unit 110 may convert commercially available alternating current (AC) power into direct current (DC) power and supply the DC power to the respective components. In the block diagram of FIG. 1, a dotted line indicates predetermined power supplied from the power supply unit 110.

The driving signal generating unit 120 may control the inverter unit 130 to generate the driving signal.

The inverter unit 130 may provide the driving signal to the motor apparatus 200. For example, the inverter unit 130 may convert the DC voltage into a plurality of phase voltages (for example, three phase voltages) depending on the predetermined signal provided from the driving signal generating unit 120. The inverter unit 130 may apply the plurality of phase voltages to a plurality of coils of the motor apparatus 200 corresponding to a plurality of phases, respectively, to allow the rotor of the motor apparatus 200 to be operated.

The zero cross point detecting unit 140 may detect back electromotive force generated by the motor apparatus 200 and may detect a plurality of zero cross points in the back electromotive force.

The zero cross point correcting unit 150 may correct the plurality of zero cross points when a time interval between the plurality of zero cross points is equal to a predetermined error period or longer.

The controlling unit 160 may control driving of the motor apparatus 200 using the plurality of zero cross points corrected by the zero cross point correcting unit 150. For example, the controlling unit 150 may perform a control to perform a phase shift based on the corrected zero cross point.

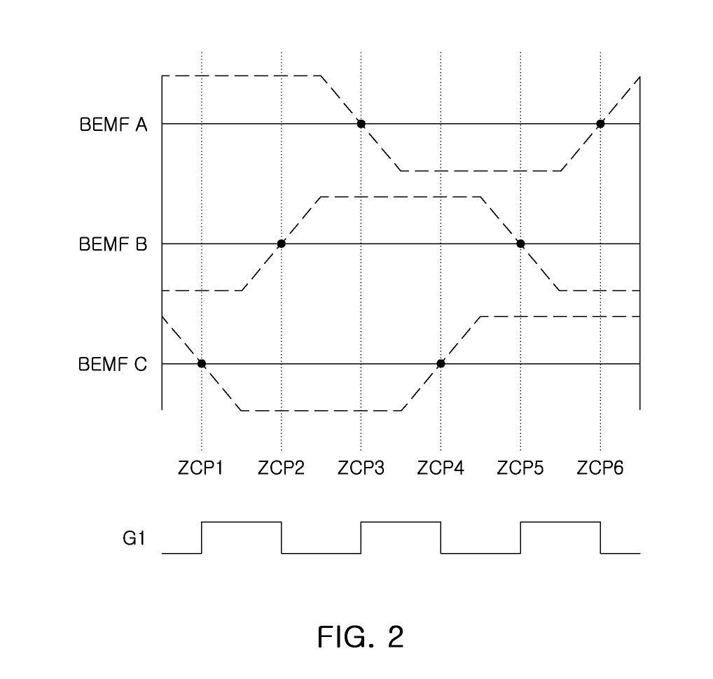

Hereinafter, exemplary embodiment of the present disclosure will be described in more detail with reference to FIGS. 2 through 5.

FIG. 2 is a reference diagram illustrating a zero cross point of back electromotive force in the case in which an error in detecting a zero cross point is not present. FIG. 2 shows an example of a three phase motor apparatus including an A phase, a B phase, and a C phase.

A general method of determining a zero cross point will be described with reference to FIG. 2.

Dotted lines shown in FIG. 2 show back electromotive forces generated in the respective phases by driving the motor apparatus 200. The zero cross point may be a point at which a sign of the back electromotive force of each phase is inverted as shown in FIG. 2.

For example, the zero cross point detecting unit 140 may be connected to the respective phases of the motor apparatus 200 and may detect the zero cross points using the back electromotive force generated in the respective phases.

G1 of FIG. 2 illustrates the zero cross points represented by a high-low value.

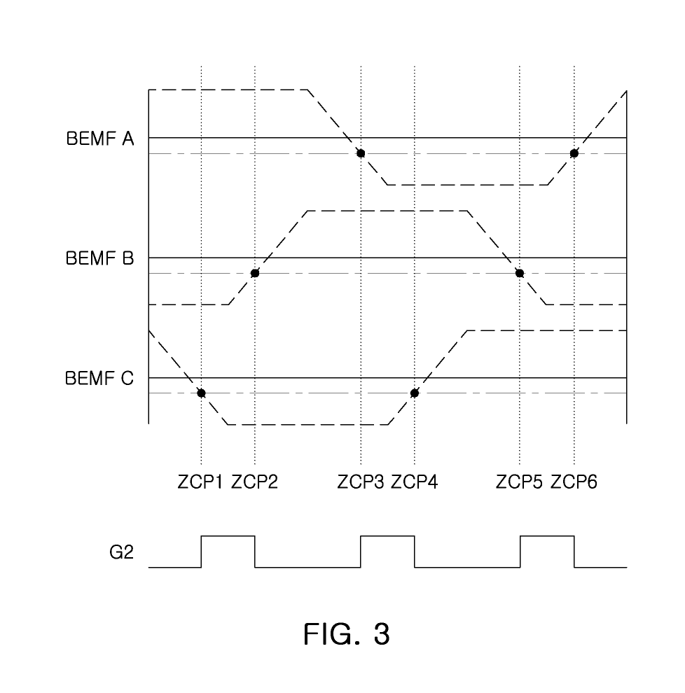

FIG. 3 is a reference diagram illustrating a zero cross point of back electromotive force in the case in which an error in detecting a zero cross point is present.

In an actual implementation, parasitic capacitance may be present in a switch of the inverter unit 130, thereby causing a negative current. The negative current may cause a voltage drop, and it may be appreciated from the example in which a reference voltage (indicated by an alternated long and short dash line) of the zero cross point becomes lower due to the voltage drop.

Therefore, it may be appreciated that the zero cross point detected from FIG. 3 has a significant error as compared to the case of an actual position of the zero cross point (the zero cross point shown in FIG. 2).

G2 of FIG. 3 illustrates the zero cross points having the error.

In a case of FIG. 3, since the controlling unit 160 derives a phase shift at an erroneous timing, efficiency of the driving of the motor may be decreased.

The zero cross point correcting unit 150 may correct the problem as described above, for example, the error in the zero cross point.

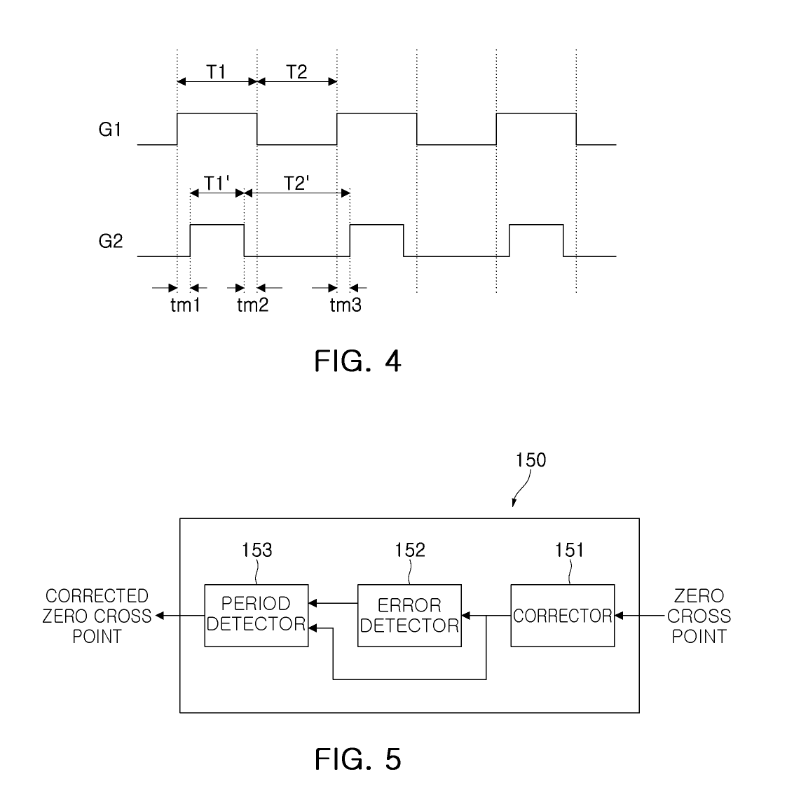

Hereinafter, the zero cross point correcting unit 150 will be described in more detail with reference to FIGS. 4 and 5.

The zero cross point correcting unit 150 may average errors within the time interval between the plurality of zero cross points and may perform the correction.

The zero cross point correcting unit 150 may determine that the errors are present in the zero cross points when a first interval between a first zero cross point and a second zero cross point, and a second interval between the second zero cross point and a third zero cross point are different from each other.

When it is determined that errors are present, the zero cross point correcting unit 150 may average the errors to perform the correction.

FIG. 4 is a reference diagram comparing G1 of FIG. 2 and G2 of FIG. 3 with each other.

Described with reference to an example of FIG. 4, the zero cross point correcting unit 150 may confirm whether the first interval T1′ between the first zero cross point and the second zero cross point, and the second interval T2′ between the second zero cross point and the third zero cross point are different from each other.

As in an example of FIG. 4, when the first interval T1′ and the second interval T2′ are different from each other, the zero cross point correcting unit 150 may perform a correction for the zero cross points.

According to an exemplary embodiment of the present disclosure, the zero cross point correcting unit 150 may calculate an average value of a difference between the first interval T1′ and the second interval T2′ and reflect the calculated average value in the first and second intervals, respectively, to perform the correction.

According to an exemplary embodiment of the present disclosure, the zero cross point correcting unit 150 may subtract the average value from a larger interval between the first interval and the second interval and add the average value to the remaining interval to thereby perform the averaging.

It may be represented by the following Equations.

In a case of an ideal G1, T1=T2, but in a case of G2, T1′ and T2′ are different from each other.

The following Equation is established therebetween.

T1=T1′+tm1+tm2

T2=T2′+tm2+tm3 [Equation 1]

Although FIG. 4 shows a case in which tm1, tm2, and tm3 have the same value, tm1, tm2, and tm3 may actually have values different from one another. The reason is that values of the voltage drop may be different from each other depending on a kind of switches connected to the respective phases.

Even in the case in which tm1, tm2, and tm3 have values different from one another, the zero cross point correcting unit 150 may average the values to thereby perform the correction.

tm1=tm2=tm3 [Equation 2]

For example, the zero cross point correcting unit 150 may consider the errors between the actual zero cross points and the ideal zero cross points as the same value and perform the correction.

Therefore, according the above-mentioned assumption, the following Equation 3 may be derived.

tm1=(T2′−T1′)/4 [Equation 3]

As a result, in order to perform the correction, the correction may be performed by adding or subtracting the averaged correction value to or from the actually detected first and second intervals T1′ and T2′.

T1″=T1′+2tm1

T2″=T2′-2tm1 [Equation 4]

For example, as in Equation 4, the corrected first interval T1″ and the corrected second interval T2″ may be each calculated from the first interval T1′ and the second interval T2′ which are measured before the correction.

The zero cross point correcting unit 150 may perform a relatively exact correction by applying an averaging technique to the error even in a case in which it uses a few resources. The reason is that even when a plurality of switches included in the inverter each having a different voltage drop value, an error between the voltage drop values is very small.

FIG. 5 is a block diagram illustrating an example of a zero cross point correcting unit 150 of FIG. 1.

Referring to FIG. 5, the zero cross point correcting unit 150 may include a period detector 151, an error detector 152, and a corrector 153.

The period detector 151 may detect periods of the plurality of zero cross points. Here, the period is related to an occurrence time of the zero cross point.

The error detector 152 may select at least two intervals between adjacent zero cross points among the plurality of zero cross points detected by the period detector 151. The error detector 152 may determine whether the at least two selected intervals are different from each other.

For example, when the two intervals are different from each other, the error detector 152 may provide information representing that the error is present to the corrector 153.

The corrector 153 may perform the correction using the average value of differences between the first interval and the second interval, for the at least two intervals in which the presence of the error is determined by the error detector 152.

Since specific operations of the corrector 153 correspond to those described in FIG. 4 and Equations 1 to 4 described above, overlapped descriptions thereof will be omitted.

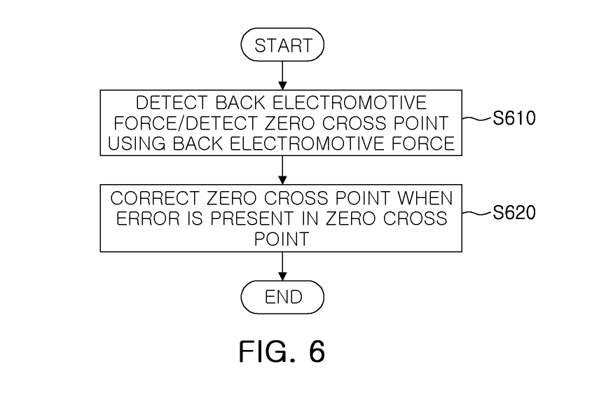

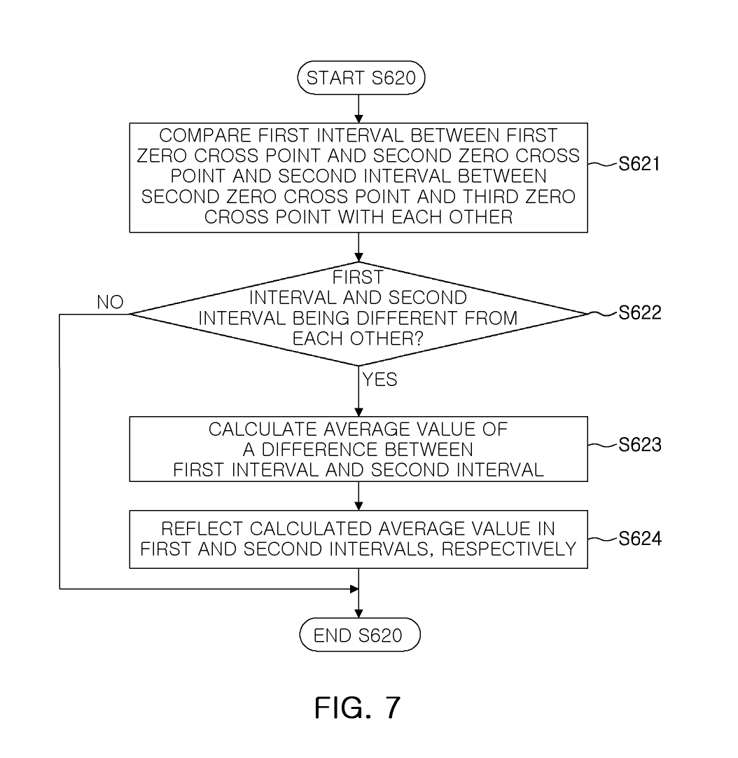

FIG. 6 is a flowchart illustrating an example of a motor driving control method according to an exemplary embodiment of the present disclosure and FIG. 7 is a flow chart illustrating an example of 5620 of FIG. 6.

Hereinafter, various examples of a motor driving control method according to an exemplary embodiment of the present disclosure will be described with reference to FIGS. 6 and 7.

Since an example of the motor driving control method according to an exemplary embodiment of the present disclosure is performed in the motor driving control apparatus 100 described above with reference to FIGS. 1 through 5, overlapped descriptions of contents the same as or corresponding to the above-mentioned contents will be omitted.

Referring to FIGS. 6 and 7, the motor driving control apparatus 100 may detect the plurality of zero cross points (ZCPs) using the back electromotive force generated by the motor apparatus 200 (S610).

Next, when a time interval between the plurality of zero cross points is equal to a predetermined error period or longer, the motor driving control apparatus 100 may correct the plurality of zero cross points (S620).

In an example of 5620, the motor driving control apparatus 100 may average errors within the time interval between the plurality of zero cross points and may perform the correction.

In an example of 5620, the motor driving control apparatus 100 may compare the first interval between the first zero cross point and the second zero cross point and the second interval between the second zero cross point and the third zero cross point with each other (S621)

When the first interval and the second interval are different from each other (YES of S622), the motor driving control apparatus 100 may determine that the error is present.

Next, the motor driving control apparatus 100 may calculate the average value of the differences between the first interval (S623) and the second interval and reflect the calculated average value in the first and second intervals, respectively (S624).

In an embodiment of the present disclosure, the motor driving control apparatus 100 may subtract the average value from a larger interval between the first interval and the second interval and add the average value to the remaining interval between the first interval and the second interval to reflect the average value.

As set forth above, according to exemplary embodiments of the present disclosure, when the error in the zero cross points of the back electromotive force is generated, the error is sensed and the averaging for the error is performed to correct the error, whereby the motor apparatus may be accurately driven.

While exemplary embodiments have been shown and described above, it will be apparent to those skilled in the art that modifications and variations could be made without departing from the spirit and scope of the present disclosure as defined by the appended claims.

What is claimed is:

1. A motor driving control apparatus, comprising:
a zero cross point (ZCP) detecting unit detecting back electromotive force generated by a motor apparatus and detecting a plurality of zero cross points in the back electromotive force;
a zero cross point correcting unit correcting the plurality of zero cross points when a time interval between the plurality of zero cross points is equal to a predetermined error period or longer; and
a controlling unit controlling driving of the motor apparatus using the plurality of corrected zero cross points.

2. The motor driving control apparatus of claim 1, wherein the zero cross point correcting unit averages the error for the time interval between the plurality of zero cross points to perform a correction.

3. The motor driving control apparatus of claim 1, wherein the zero cross point correcting unit determines that the error is present when a first interval between a first zero cross point and a second zero cross point and a second interval between the second zero cross point and a third zero cross point are different from each other.

4. The motor driving control apparatus of claim 3, wherein the zero cross point correcting unit calculates an average value of a difference between the first interval and the second interval and reflects the calculated average value in the first and second intervals, respectively.

5. The motor driving control apparatus of claim 4, wherein the zero cross point correcting unit subtracts the average value from a larger interval between the first interval and the second interval and adds the average value to the remaining interval.

6. The motor driving control apparatus of claim 1, wherein the zero cross point correcting unit includes:
a period detector detecting periods of the plurality of zero cross points;
an error detector selecting at least two intervals between adjacent zero cross points among the plurality of zero cross points detected by the period detector and determining whether the at least two selected intervals are different from each other; and
a corrector performing a correction using an average value of a difference between the two intervals, for the at least two intervals in which a presence of the error is determined by the error detector.

7. A motor system, comprising:
a motor apparatus performing a rotation operation according to a driving signal; and
a motor driving control apparatus detecting a plurality of zero cross points (ZCPs) using back electromotive force generated by the motor apparatus and correcting the plurality of zero cross points when a time interval between the plurality of zero cross points has an error to generate the driving signal.

8. The motor system of claim 7, wherein the motor driving control apparatus includes:
a zero cross point (ZCP) detecting unit detecting the back electromotive force generated by the motor apparatus and detecting the plurality of zero cross points in the back electromotive force;
a zero cross point correcting unit correcting the plurality of zero cross points when a time interval between the plurality of zero cross points is equal to a predetermined error period or longer; and
a controlling unit controlling driving of the motor apparatus using the plurality of corrected zero cross points.

9. The motor system of claim 8, wherein the zero cross point correcting unit averages the error for the time interval between the plurality of zero cross points to perform a correction.

10. The motor system of claim 8, wherein the zero cross point correcting unit determines that the error is present when a first interval between a first zero cross point and a second zero cross point and a second interval between the second zero cross point and a third zero cross point are different from each other.

11. The motor system of claim 10, wherein the zero cross point correcting unit calculates an average value of a difference between the first interval and the second interval and reflects the calculated average value in the first and second intervals, respectively.

12. The motor system of claim 11, wherein the zero cross point correcting unit subtracts the average value from a larger interval between the first interval and the second interval and adds the average value to the remaining interval.

13. The motor system of claim 8, wherein the zero cross point correcting unit includes:
a period detector detecting periods of the plurality of zero cross points;
an error detector selecting at least two intervals between adjacent zero cross points among the plurality of zero cross points detected by the period detector and determining whether the at least two selected intervals are different from each other; and
a corrector performing a correction using an average value of a difference between the two intervals, for the at least two intervals in which a presence of the error is determined by the error detector.

14. A motor driving control method performed in a motor driving control apparatus controlling driving of a motor apparatus, the method comprising:
detecting a plurality of zero cross points (ZCPs) using back electromotive force generated by the motor apparatus; and
correcting the plurality of zero cross points when a time interval between the plurality of zero cross points is equal to a predetermined error period or longer.

15. The method of claim 14, wherein the correcting of the plurality of zero cross points includes averaging the error for the time interval between the plurality of zero cross points to perform a correction.

16. The method of claim 14, wherein the correcting of the plurality of zero cross points includes:
determining that the error is present when a first interval between a first zero cross point and a second zero cross point and a second interval between the second zero cross point and a third zero cross point are different from each other; and
calculating an average value of a difference between the first interval and the second interval and reflecting the calculated average value in the first and second intervals, respectively.

17. The method of claim 16, wherein the reflecting of the calculated average value in the first and second intervals, respectively, includes:
subtracting the average value from a larger interval between the first interval and the second interval; and
adding the average value to the remaining interval between the first interval and the second interval.
